(19) United States
(12) Patent Application Publication
(10) Pub. No.: US 2026/0107079 A1
(43) Pub. Date: Apr. 16, 2026

(54) IN-VEHICLE SPEAKER SYSTEM

(71) Applicant: AAC Acoustic Technologies (Shanghai) Co., Ltd., Shanghai (CN)

(72) Inventors: Huan Ge, Shanghai (CN); Henglizi Zhang, Shanghai (CN); Lijian Ye, Shanghai (CN)

(21) Appl. No.: 18/966,030

(22) Filed: Dec. 2, 2024

Related U.S. Application Data
(63) Continuation of application No. PCT/CN2024/124857, filed on Oct. 15, 2024.

(51) Int. Cl. H04R 1/02

(52) U.S. Cl. CPC H04R 1/02; H04R 2499/13

(57) ABSTRACT

The in-vehicle speaker system provided by the present disclosure includes: a first sound zone located in a left near-ear area of a passenger; a second sound zone located in a right near-ear area of the passenger; a third sound zone located on a side of the second sound zone away from the first sound zone; and a fourth sound zone located on a side of the third sound zone away from the second sound zone; where the first sound zone is provided with a first speaker array consisting of M speakers, and the second sound zone is provided with a second speaker array consisting of N speakers, where N is a natural number greater than M. The in-vehicle speaker system provided by the present disclosure has high acoustic isolation in the seat area, providing a good listening experience for passengers.

### TECHNICAL FIELD

The present disclosure relates to the technical field of in-vehicle acoustic, and more particularly to an in-vehicle speaker system.

### BACKGROUND

In-vehicle independent sound zone technology is an advanced sound field control technology that controls the play of audio content in designated areas inside the vehicle, and is a highly demanded technology among consumers. This technology can be utilized for private conversations within vehicles, ensuring the privacy of communication content, and for the zoned play of in-vehicle entertainment audio, satisfying the needs of passengers in different locations to simultaneously enjoy diverse entertainment audio or the needs of non-interference between those who want to enjoy entertainment audio and others who want to rest or engage in conversations.

Using arrays of micro speakers arranged on the in-vehicle headrests or seats for independent sound zone control is a solution to achieve audio directional emission for passengers at different positions inside the vehicle. This solution fully utilizes the advantage of the small size of micro speakers, allowing flexible placement of one or multiple arrays at locations such as headrests, seats, or ceilings and increasing the number of speakers. Further, these speakers are closer to the listeners, so that a better independent sound zone control effect can be achieved.

Generally, the door speakers and ceiling speakers in a vehicle are arranged symmetrically according to the vehicle, and the headrest speakers are generally arranged symmetrically inside the headrest relative to the headrest. However, for the algorithm for controlling independent sound zones in a vehicle, the symmetrical arrangement of speakers may result in uneven isolation of the independent sound zones on two sides of the listener, thereby impairing the listening experience of the passengers.

Therefore, there is a need to propose a new in-vehicle speaker system to address the aforementioned issues.

### SUMMARY

The objective of the present disclosure is to overcome the aforementioned technical issues and provide an in-vehicle speaker system with high average isolation.

To achieve the aforementioned objective, the present disclosure proposes an in-vehicle speaker system including:
a first sound zone located in a left near-ear area of a passenger,
a second sound zone located in a right near-ear area of the passenger,
a third sound zone located on a side of the second sound zone away from the first sound zone, and
a fourth sound zone located on a side of the third sound zone away from the second sound zone;
where the first sound zone is provided with a first speaker array consisting of M speakers, and the second sound zone is provided with a second speaker array consisting of N speakers, where N is a natural number greater than M.

Preferably, the in-vehicle speaker system includes a first seat for the passenger, and the first sound zone and the second sound zone are symmetrically arranged on two sides of the passenger along a central axis of the first seat.

Preferably, the speakers in the first speaker array and/or the second speaker array are arranged in a matrix form.

Preferably, the in-vehicle speaker system further includes a second seat for the passenger. The second seat is adjacent to the first seat. The third sound zone and the fourth sound zone are symmetrically arranged on two sides of the passenger along a central axis of the second seat. Another second speaker array is provided in the third sound zone, and another first speaker array is provided in the fourth sound zone.

Preferably, the first speaker array includes four speakers arranged in a 2×2 array.

Preferably, the second speaker array includes six speakers arranged in a 2×3 array.

Compared to related technologies, in the in-vehicle speaker system provided by the present disclosure, speaker arrays with different numbers of speakers are arranged within the sound zones of the near-ear areas on the left and right sides of the passenger, and the speaker array located in the sound zone adjacent to the neighboring seat includes more speakers. This asymmetric arrangement of speaker arrays not only effectively improves the average acoustic isolation in the seat area and improves the listening experience of the passenger, but also achieves a better audio directional emission effect for different passenger seats in the vehicle.

### BRIEF DESCRIPTION OF THE DRAWINGS

In order to illustrate the technical solutions in the embodiments of the present disclosure more clearly, the drawings used in the description of the embodiments are briefly described below. It is apparent that the drawings in the following description show only some embodiments of the present disclosure, and other drawings may be obtained by those of ordinary skill in the art based on these drawings without any creative efforts.

FIG. 1 is a schematic diagram illustrating the arrangement of speaker arrays in an in-vehicle speaker system provided by the present disclosure.

FIG. 2 is another schematic diagram illustrating the arrangement of speaker arrays in the in-vehicle speaker system provided by the present disclosure.

FIG. 3 is a schematic diagram illustrating the comparison of isolation between the in-vehicle speaker system provided by the present disclosure and an existing in-vehicle speaker system.

FIG. 4 is a schematic diagram illustrating the arrangement of speaker arrays in an existing in-vehicle speaker system.

FIG. 5 is a schematic diagram illustrating the responses of a speaker array in different sound zones in an existing in-vehicle speaker system when the first seat is unoccupied.

FIG. 6 is a schematic diagram illustrating the responses of the speaker array in different sound zones in the existing in-vehicle speaker system when the first seat is occupied by a passenger.

FIG. 7 is a schematic diagram illustrating the isolation of the sound zones in the existing in-vehicle speaker system when the first seat is occupied by a passenger.

### DETAILED DESCRIPTION OF THE EMBODIMENTS

The technical solutions in the embodiments of the present disclosure are clearly and comprehensively described below with reference to the accompanying drawings of the embodiments of the present disclosure. Apparently, the described embodiments are merely a subset of the embodiments of the present disclosure, not exhaustive. Based on the embodiments of the present disclosure, all other embodiments obtained by those of ordinary skill in the art of the present disclosure without creative efforts fall within the scope of protection of the present disclosure.

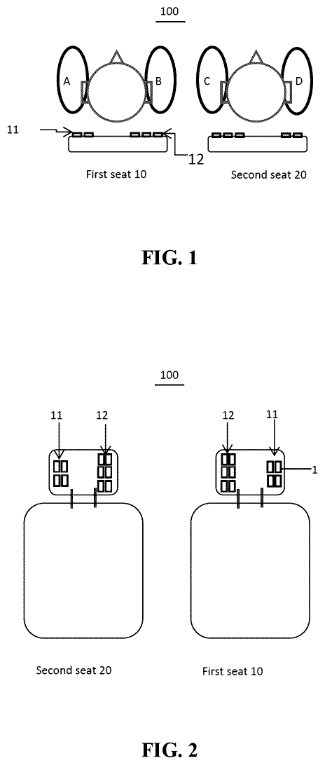

As shown in FIG. 1 to FIG. 2, the present disclosure provides an in-vehicle speaker system 100 including:
a first sound zone A located in a left near-ear area of a passenger,
a second sound zone B located in a right near-ear area of a passenger,
a third sound zone C located on a side of the second sound zone B away from the first sound zone A, and
a fourth sound zone D located on a side of the third sound zone C away from the second sound zone B;
where the first sound zone A is provided with a first speaker array 11 consisting of M speakers 1, and the second sound zone B is provided with a second speaker array 12 consisting of N speakers 1, where N is a natural number greater than M.

Specifically, the in-vehicle speaker system 100 includes a first seat 10 and a second seat 20 for passengers. The second seat 20 is adjacent to the first seat 10. It is conceivable that the first seat 10 may be the driver's seat, and the second seat 20 may be the passenger seat or a seat adjacent to it in the rear row.

The first sound zone A and the second sound zone B are symmetrically arranged on two sides of the passenger along a central axis of the first seat 10. Similarly, the third sound zone C and the fourth sound zone D are symmetrically arranged on two sides of the passenger along a central axis of the second seat 20.

Another second speaker array 12 is provided in the third sound zone C, and another first speaker array 11 is provided in the fourth sound zone D. That is, more speakers 1 are arranged in the area of the first seat 10 or the second seat 20 that is close to the other seat.

As shown in FIG. 2, the speakers in the first speaker array 11 and/or the second speaker array 12 are arranged in a matrix form.

Specifically, the first speaker array 11 includes four speakers 1 arranged in a 2×2 array. The second speaker array 12 includes six speakers arranged in a 2×3 array. In other embodiments, different numbers of speakers and different array arrangements may be selected according to actual needs.

As shown in FIG. 4, in an existing in-vehicle speaker system, the speakers mounted on the first seat 10 and the second seat 20 are symmetrically arranged along the central axis of the seats. That is, the number of speakers in the left near-ear area of the passenger is the same as the number of speakers in the right near-ear area, that is, the number of speakers in the first sound zone A is equal to the number of speakers in the second sound zone B. However, this symmetrical layout for each seat does not fully take advantage of the speaker array in sound field control within independent sound zones.

In FIG. 4, the first sound zone A and the second sound zone B of the in-vehicle speaker system are designated as acoustically bright zones, while the third sound zone C and the fourth sound zone D are designated as acoustically dark zones. Playback of the target sound source within the bright zones is enhanced, while playback within the dark zones is weakened.

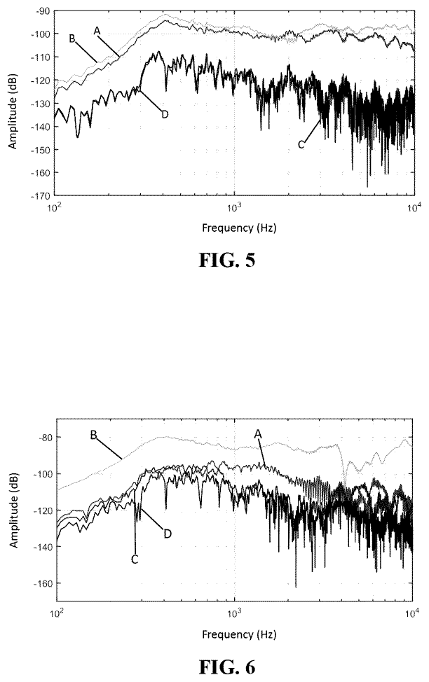

Taking the first seat 10 as an example, since the speaker arrays on the first seat 10 are adjacent to the passenger's head, the sound emitted by the speakers is blocked by the passenger, thus causing certain interference. FIG. 5 and FIG. 6 demonstrate the impact of this interference. Corresponding to the layout shown in FIG. 4, FIG. 5 and FIG. 6 illustrate the responses of the speaker located in the right near-ear area of the passenger in the first sound zone A, second sound zone B, third sound zone C, and fourth sound zone D. Curve A represents the acoustic response of the speaker in the first sound zone A, curve B represents the acoustic response of the speaker in the second sound zone B, curve C represents the acoustic response of the speaker in the third sound zone C, and curve D represents the acoustic response of the speaker in the fourth sound zone D.

FIG. 5 corresponds to the situation where the first seat 10 is not occupied. The response of the speaker in the first sound zone A is similar to the response in the second sound zone B, and significantly greater than the response in the third sound zone C and the fourth sound zone D. FIG. 6 corresponds to the situation where the first seat 10 is occupied. As can be seen, due to the obstruction by the passenger, the response of the speaker in the first sound zone A is significantly smaller than the response in the second sound zone B. The amplitude of the response in the first sound zone A is close to that in the acoustically dark zones, the third sound zone C and the fourth sound zone D. In this situation, the control effect of the speaker at that position on the first sound zone A of the acoustic bright zone is significantly weakened.

In FIG. 4, the first sound zone A in the left near-ear area of the passenger is farther from the third sound zone C and the fourth sound zone D than the second sound zone B. Coupled with the obstruction of the passenger, when using the speaker of the first seat 10, if the same sound level is produced at the first sound zone A or the second sound zone B, the leakage of sound from the first sound zone A to the third sound zone C or the fourth sound zone D is smaller than that to the second sound zone B.

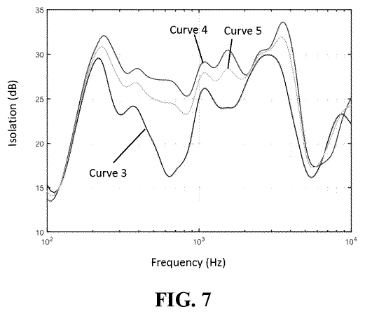

As shown in FIG. 7, curve 3 represents the relative isolation between the second sound zone B and the third sound zone C, curve 5 represents the relative isolation between the first sound zone A and the third sound zone C, and curve 4 represents the average isolation between the first seat 10 and the second seat 20. Due to the greater distance between the first sound zone A and the third sound zone C, as well as the obstruction of the passenger, the sound emitted by the speaker array under the independent sound zone control algorithm has a greater response in the first sound zone A than in the second sound zone B. Regarding the average value at the first seat 10, the response in the second sound zone B lowers the average isolation between the first seat 10 and the second seat 20. Therefore, from the perspective of independent sound zone control, more emphasis needs to be placed on controlling the isolation between the second sound zone B and the third sound zone C.

Therefore, in the in-vehicle speaker system 100 provided by the present disclosure, an acoustic bright zone, namely the first sound zone A and the second sound zone B, is created in the area of the first seat 10, and an acoustic dark zone, namely the third sound zone C and the fourth sound zone D, is created in the area of the second seat 20. Taking the first seat 10 as an example, on the side closer to the acoustic dark zone, namely the second sound zone B, N speakers 1 are arranged in the second speaker array 12, and on the side farther from the acoustic dark zone, namely the first sound zone A, M speakers 1 are arranged in the first speaker array 11, where N>M. This arrangement, with a fixed number of speakers on the first seat 10, more speakers are placed on the side closer to the acoustic dark zone to avoid the impact of passenger obstruction, which can improve the isolation effect of the sound zone on the side closer to the acoustic dark zone, thereby improving the average isolation effect of the entire seat area.

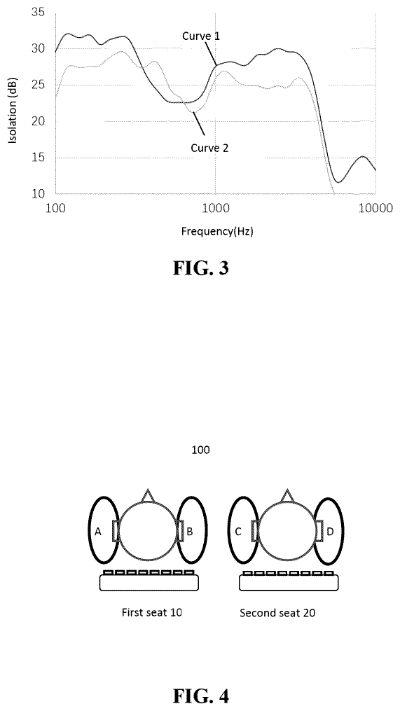

As shown in FIG. 3, curve 1 represents the independent sound zone control isolation of the in-vehicle speaker system 100 provided by the present disclosure, curve 2 represents the independent sound zone control isolation of the existing in-vehicle speaker system. It can be seen that compared with the existing technology, the independent sound zone control isolation of the in-vehicle speaker system 100 in the present disclosure is significantly improved, effectively improving the listening experience of passengers using the in-seat speakers in vehicle.

It will be appreciated that in the embodiments provided by the present disclosure, the aforementioned speakers are all arranged in the headrests of vehicle seats, while in other embodiments, speakers located in positions such as vehicle ceiling, A/B pillars, doors, and center console can also adopt the arrangement of the speaker array in the present disclosure.

Compared to related technologies, in the in-vehicle speaker system provided by the present disclosure, speaker arrays with different numbers of speakers are arranged within the sound zones of the near-ear areas on the left and right sides of the passenger, and the speaker array located in the sound zone adjacent to the neighboring seat includes more speakers. This asymmetric arrangement of speaker arrays not only effectively improves the average acoustic isolation in the seat area and improves the listening experience of the passenger, but also achieves a better audio directional emission effect for different passenger seats in the vehicle.

The above description only shows embodiments of the present disclosure. It should be noted herein that for those skilled in the art, improvements may be made without departing from the inventive concept of the present disclosure, and those improvements still fall within the scope of protection of the present disclosure.

What is claimed is

1. An in-vehicle speaker system, comprising:
a first sound zone located in a left near-ear area of a passenger,
a second sound zone located in a right near-ear area of the passenger,
a third sound zone located on a side of the second sound zone away from the first sound zone, and
a fourth sound zone located on a side of the third sound zone away from the second sound zone;
wherein the first sound zone is provided with a first speaker array consisting of M speakers, and the second sound zone is provided with a second speaker array consisting of N speakers, wherein N is a natural number greater than M.

2. The in-vehicle speaker system according to claim 1, wherein the in-vehicle speaker system comprises a first seat for the passenger, and the first sound zone and the second sound zone are symmetrically arranged on two sides of the passenger along a central axis of the first seat.

3. The in-vehicle speaker system according to claim 1, wherein the speakers in the first speaker array and/or the second speaker array are arranged in a matrix form.

4. The in-vehicle speaker system according to claim 1, wherein the in-vehicle speaker system further comprises a second seat for the passenger, wherein the second seat is adjacent to the first seat, the third sound zone and the fourth sound zone are symmetrically arranged on two sides of the passenger along a central axis of the second seat, another second speaker array is provided in the third sound zone, and another first speaker array is provided in the fourth sound zone.

5. The in-vehicle speaker system according to claim 3, wherein the first speaker array comprises four speakers arranged in a 2×2 array.

6. The in-vehicle speaker system according to claim 3, wherein the second speaker array comprises six speakers arranged in a 2×3 array.
